(19) United States
(12) Patent Application Publication
(10) Pub. No.: US 2012/0078597 A1
(43) Pub. Date: Mar. 29, 2012

(54) MOBILE DEVICE WITH A MODELING PLATFORM

(75) Inventors: Alsaad Ishaq, Dodhpur (IN); Anubhav Pradhan, Bareilly (IN)

(73) Assignee: INFOSYS TECHNOLOGIES LIMITED, Bangalore (IN)

(21) Appl. No.: 13/070,708

(22) Filed: Mar. 24, 2011

(30) Foreign Application Priority Data
Sep. 27, 2010 (IN) 2829/CHE/2010

(51) Int. Cl. G06G 7/48

(52) U.S. Cl. 703/6

(57) ABSTRACT

The present invention provides a process modeling platform installed on a mobile device such as a cell phone, a laptop or a Personal Digital Assistant (PDA). The platform includes a User Interface module that enables the user to interact with the platform. The platform further includes a template module and a model engine. The template module enables the user to use a pre-loaded template for modeling. The model engine enables the user to use a pre-loaded algorithm for modeling. The platform also includes a storage module. The primary function of the storage module includes storage of various templates, algorithms and models. An administrative module, which is also a part of the platform, performs generic infrastructure services that are required by the core logic of the platform.

### FIELD OF THE INVENTION

The present invention relates in general to mobile device. More particularly, it relates to a process modeling platform installed on a mobile device.

### BACKGROUND OF THE INVENTION

Today professionals like Analysts, Consultants, Architects and Designers across various industry verticals typically use age old pen and paper ways for noting discussed points, gathering customer requirements and capturing process flows. Thereafter, they transfer and process the collected data using modeling tools available on data processing machines such as laptops and desktops. The scenario mentioned above is applicable especially to modeling of systems engineering processes. Systems engineering is a study of how engineering projects should be designed and managed.

For designing various process models, a systems engineer takes down the various notes using pen and paper. The outlined problem is then understood by the systems engineer, followed by a discussion between the stakeholders and the involved teams, and their feedback is again noted on a piece of paper.

Although its use is widespread, the notepad-pen approach of taking down notes and exchanging data has several drawbacks associated with it. The accuracy of data captured varies with the dexterous capabilities of the individual collecting it. Another factor that discounts consistency and accuracy is the usage of different languages by different individuals to communicate. The productivity also gets compromised in case rework is required at any stage of model development.

Hence, there is a need for a system for model creation that is portable and handy, and intelligent enough to support the model development architecture, depending on the domain in which it is used. Since the system provides a uniform format of model creation, it will thereby assist in eliminating the errors introduced into model creation due to an individual's subjectivity.

### BRIEF SUMMARY OF THE INVENTION

The present invention provides a process modeling platform installed on a mobile device such as a cell phone. The platform comprises various modules that enable a user, for example, a systems engineer to create models pertaining to a process efficiently and accurately.

The present invention also provides a mobile device on which the process modeling platform is installed.

According to an embodiment of the present invention, the process modeling platform is installed on a mobile device such as a cell phone, a laptop or a Personal Digital Assistant (PDA). The platform includes a user interface configured to enable the user to provide inputs related to the process and to interact with the platform. The user interface further includes a work space for carrying out modeling and a template interface to enable the user to view one or more process, domain and model specific templates. The second component of the platform is a template module that is communicatively coupled with the template interface. The platform further includes a model engine communicatively coupled to the user interface and the template module. The template module along with the template interface enables the user to access and select from the one or more templates that he or she wishes to use during modeling. The model engine enables the user to access one or more algorithms to model the process corresponding to the selected templates. A storage module is also provided in the platform for storing the created model, and the various templates and algorithms required during modeling. In one or more illustrative embodiments of the invention, the platform also includes an administrative module for activities such as caching, logging, audit trails, error correction, authorization and ensuring security of the platform and its contents.

An advantage of the present invention is that it enables various users to carry out process modeling using a simple tool and various standard templates, and in a standard format. This leads to the removal of errors introduced into modeling due to an individual's subjectivity and enhances consistency. Another advantage of the present invention is that it reduces the amount of effort spent during rework, if any, and in turn enhances productivity.

### BRIEF DESCRIPTION OF THE DRAWINGS

Various embodiments of the invention will hereinafter be described in conjunction with the appended drawings provided to illustrate, and not to limit, the scope of the invention, wherein like designations denote like elements, and in which:

FIG. 1 is a block diagram of a process modeling platform, in accordance with an embodiment of the invention;

FIG. 2 is an exemplary modeling palette of the user interface of the platform, in accordance with an embodiment of the invention;

FIG. 3 is an exemplary workspace of the user interface of the platform, in accordance with an embodiment of the invention;

FIG. 4 illustrates an exemplary template interface of the user interface of the platform, in accordance with an embodiment of the invention;

FIG. 5 is an exemplary keypad of the user interface of the platform, in accordance with an embodiment of the invention;

FIG. 6 is an exemplary mobile device comprising the process modeling platform, in accordance with an embodiment of the invention; and

FIG. 7 is a block diagram depicting another embodiment of the invention.

### DETAILED DESCRIPTION OF THE INVENTION

Typically, across all Industry verticals, when an analyst or a system architect visits a client to gather business requirements, he or she generally scribbles the notes on a notepad. These notes are later converted into models after discussions with stakeholders using tools available on machines such as personal computers. The soft version is then shared across teams to further analyze and design the actual system.

The models that are shared amongst teams generally include already known representations such as Business Process Modeling Notation (BPMN), Functional Flow Block Diagrams (FFBD), Data Flow Diagrams (DFD), N-Squared Charts, Integration Definition for Function Modeling (IDEF0) Diagram, UML Use case and Sequence diagrams, USL Function Maps and Type Maps and Enterprise Architecture Frameworks.

The present invention provides a platform for designing process models using such representations. In an embodiment, the process can be a systems engineering process. It will be readily apparent to those skilled in the art that the representations mentioned above are merely exemplary and the platform can be easily made compatible to develop other representations that are known currently or that will be developed in the future. A user such as an analyst or an architect can create the said models on the platform using the process, domain and model specific templates; and algorithms built-in to the platform. The user can also create new templates or algorithms, on the platform, that may be required during modeling. The said platform can be generally installed on any mobile device such as a mobile phone, a laptop or a Personal Digital Assistant (PDA). In an embodiment, a mobile device can be provided that is configured to host the modeling platform alone.

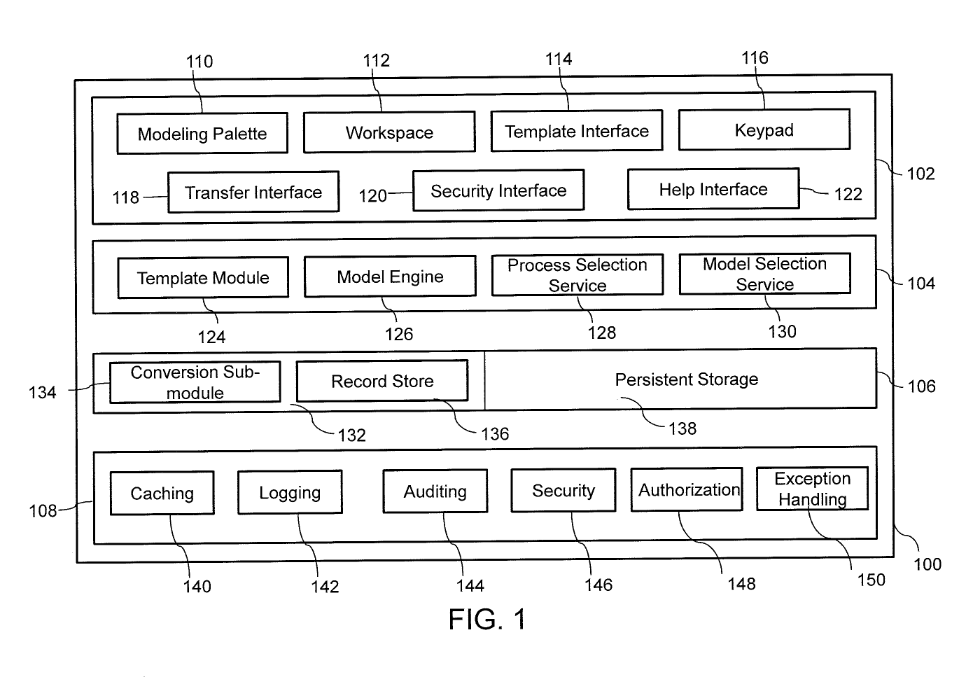

FIG. 1 illustrates a block diagram of a process modeling platform 100, in accordance with an embodiment of the invention. As shown in FIG.1, platform 100 possesses various modules in its application architecture. In this embodiment, the platform is shown to have five modules and the various sub-modules included in these modules. 102 is a User Interface module that enables the user to interact with the platform. 104 is the application services layer and includes Template module 124 and model engine 126. Template module 124 enables the user to use a pre-loaded template for modeling. Model engine 126 enables the user to use a pre-loaded algorithm for modeling. 106 depicts the storage module. The primary function of storage module 106 includes storage of various templates, algorithms and models. 108 represents the administrative module. Administrative module 108 performs generic infrastructure services that are required by the core logic of platform 100.

The detailed working of platform 100 along with its components has been described below.

User interface 102 is shown to include a workspace 112. Workspace 112 is the virtual area where the user can gather various templates, codes etc, to draw the models. In an embodiment, multiple users can access workspace 112 simultaneously to create models. In various embodiments, access rights to workspace 112 can be configured to provide selective access to different users as per requirement. For example, users from one team can be provided just the read-only access rights to the workspace, while the users from another team can login to the workspace to edit and create various models.

114 is the template interface that enables the user to view a variety of templates that have been stored into the platform. Various process and model specific templates that comprise the most frequently used set or subset of the model diagram of a particular process can be pre-loaded into the platform. Similarly, the platform can also be equipped with domain specific process templates.

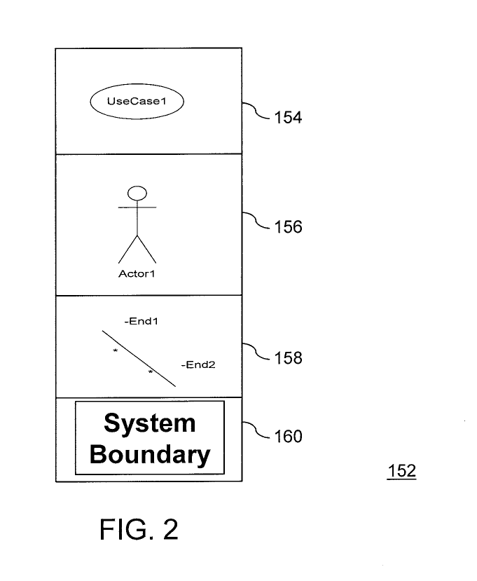

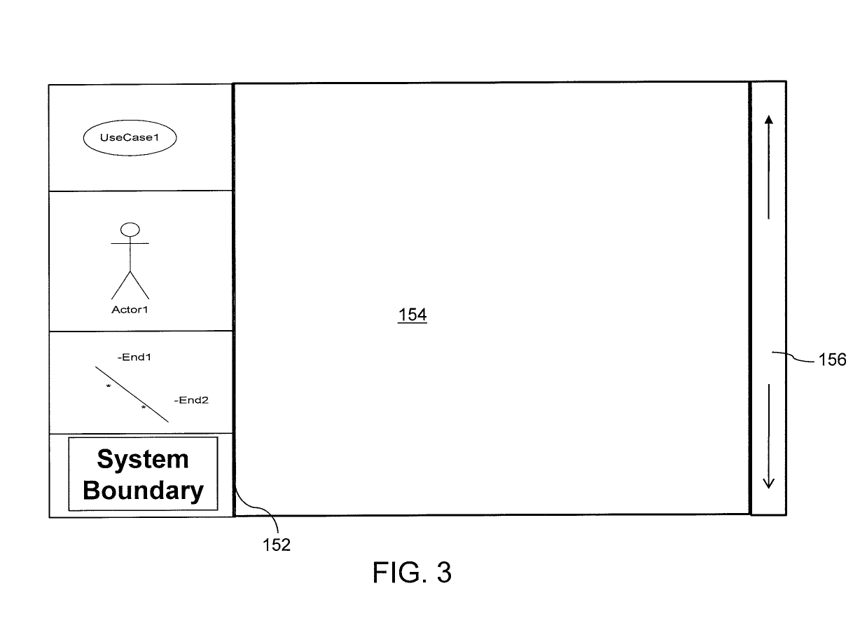

In various embodiments of the present invention, user interface 102 of platform 100 can also include sub-modules such as a modeling palette 110, a keypad 116, a transfer interface 118, a security interface 120 and a help interface 122. The functions performed by these exemplary sub-modules are as follows. Modeling palette 110 serves as a tool box for the user to draw various shapes and components used in the model. An exemplary modeling palette has been depicted in FIG. 2. Keypad 116 can be used to provide an input to platform 100. The keypad can be a physical keypad or a touchpad. In an embodiment, the keypad of the mobile device is configured to be used for interacting with the platform, thus, eliminating the need for a separate keypad for platform 100. An exemplary keypad has been depicted in FIG. 3. User interface 102 can also be configured to receive voice commands or gestures as an input from the user. Hence, the input to the platform can be multi-modal such as touch, text, voice, gestures or combinations thereof. It will be apparent to those skilled in the art that platform 100 can be configured to work based on any form of input in addition to those mentioned above.

Transfer interface 118 is used to monitor the transfer of the created model or a part to an external device from the host mobile device. Transfer interface 118 is communicatively coupled to security sub-module 146 of administrative module 108. Security sub-module 146 and its functionality have been described later. 120 is the Security Interface. It helps in monitoring the encryption of the created model for storing the model in storage module 106 (described later). It also helps in monitoring the security of the connection between the mobile device and the external device. Again, security interface 120 is also communicatively coupled with security sub-module 146. Help interface 122 is available to be accessed by the user at anytime while working with platform 100. Help interface 122 enables the user to access various user guides stored in record store 136 of storage module 106. The user guides contain information regarding the operation and functioning of platform 100 and its components.

Template module 124 is communicatively coupled with template interface 114 of user interface 102. Together, template module 124 and template interface 118 enable the user to view, select and use the pre-loaded model, domain and process specific templates of platform 100. To cite an example, while modeling a software process, a template for “ternary association” can be provided in a class diagram which will enable the user to create the association just by typing the appropriate class names, roles and association names. The individual drag and drop of the classes and their association can be eliminated. Further, template module 124 also supports creation of new templates, and editing and deletion of existing process templates. For example, a ternary association could be combined with the aggregation to create a bigger set of templates.

Model engine 126 is communicatively coupled with template module 124 and user interface 102. It enables the user to view, select and use various algorithms and data structures required corresponding to the process being modeled and the selected templates. The user can also create new algorithms and store them for future use through model engine 126.

Application services layer 104 is also shown to comprise a process selection service 128 and a model selection service 130. These services enable the user to select the desired process to be modeled and to select an already created model, respectively, using user interface 102. In various embodiments, model engine 126 and template module 124 can be parts of different architecture layers.

In this embodiment, storage module 106 is shown to have two parts. 132 is storage access part. Storage access part 132 includes a conversion sub-module 134 and a record store 136. Conversion sub-module 134 can convert the created model from a first form i.e. its native data format to a second form i.e. another data format and vice versa as and when required. This helps in increasing the interoperability of the model across various industry verticals. For example, in case a model for a software process finds application in other industry verticals, the conversion sub-module can be used to convert the XML based model data to a required format. Record store 136 is used to store various preloaded and created templates, algorithms and models. It also stores various user guides as described above.

138 represents the persistent storage part or the native storage sub-module of storage module 106. Persistent storage 138 is used for storing the created models in a native format. This helps in increasing the interoperability of the model across other existing or future platforms of the industry vertical. For example, in the software industry, UML models or SysML models can be persisted in XML format to ensure the flexibility of the models among platforms. In an embodiment, the entire storage module 106 or a part can be external to the platform and the mobile device. For example, it can be a flash memory plug and play device.

In this embodiment, administrative module 108 is shown to comprise the following sub-modules. 150 is the Exception Handling sub-module. It manages the un-forced errors and exceptions that occur in platform 100 during its working. 140 is the Caching sub-module. This sub-module stores the frequently used data for ready reference by platform 100 during modeling or templating processes. 142 is the Logging sub-module. It serves to log important and identified events during the process modeling and templating exercise. 144 is the Auditing sub-module. It stores an audit trail of events. In other words, it maintains a record of platform activity realized both by platform 100 itself and its application processes; and by the users. 146 is the security sub-module. Together with security interface 120, security sub-module 146 allows secure storage of data i.e. in an encrypted format, in record store 136. Further, in conjunction with transfer interface 118, security sub-module 146 allows secure transfer of data to and from the mobile device. Native mobile transfer mechanisms such as Bluetooth, Infrared can be used to connect the mobile device to an external device. In an embodiment, the transfer functionality can be fulfilled by a separate sub module called the Transfer sub-module. However, it will be apparent to those skilled in the art that other transfer methods, both wired and wireless, can also be employed. 148 is the authorization sub-module. It performs the function of authorizing and authenticating the logging in and out of platform 100.

For the purpose of this description, the exemplary components of the modeling platform have been elaborated below as they are used in the software industry. However, it will be apparent to those skilled in the art that the modeling platform can be as conveniently used in other industry verticals also.

FIG. 2 illustrates an exemplary modeling palette 152 of user interface 102 as described in FIG. 1. 152 represents a Use Case Modeling Palette. A use case diagram is prepared in the Unified Modeling Language (UML) and is a type of behavioral diagram defined by and created from a use-case analysis. 154 is the icon for “Use Case”, a use case in software engineering and systems engineering is a description of a system's behavior as it responds to a request that originates from outside of that system. 156 is the icon for “Actor”, an actor in the UML specifies a role played by a system, a process or a user. 158 is the icon for “Association Relationship”. Association relationship depicts the static relationship shared amongst two or more actors. 158 is the icon for “System Boundary”. A system boundary is a boundary that separates the internal components of a system from external entities.

FIG. 3 illustrates an exemplary workspace as described in FIG. 1. 154 depicts a Use Case Modeling Workspace. 152 is the Use Case Modeling Palette as described in FIG. 2, while 156 is the workspace scroller.

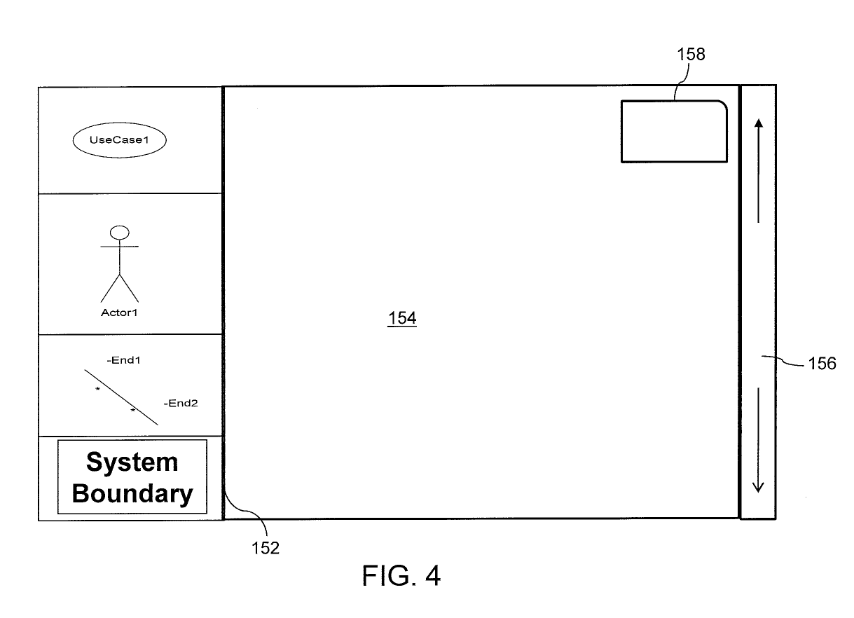

FIG. 4 illustrates an exemplary template interface as described in FIG. 1. In a use case modeling scenario, 158 depicts a handy template interface that would be available to the user to easily create the use case diagram. 152, 154 and 156 are the modeling palette, workspace and the workspace scroller respectively, and are as described above.

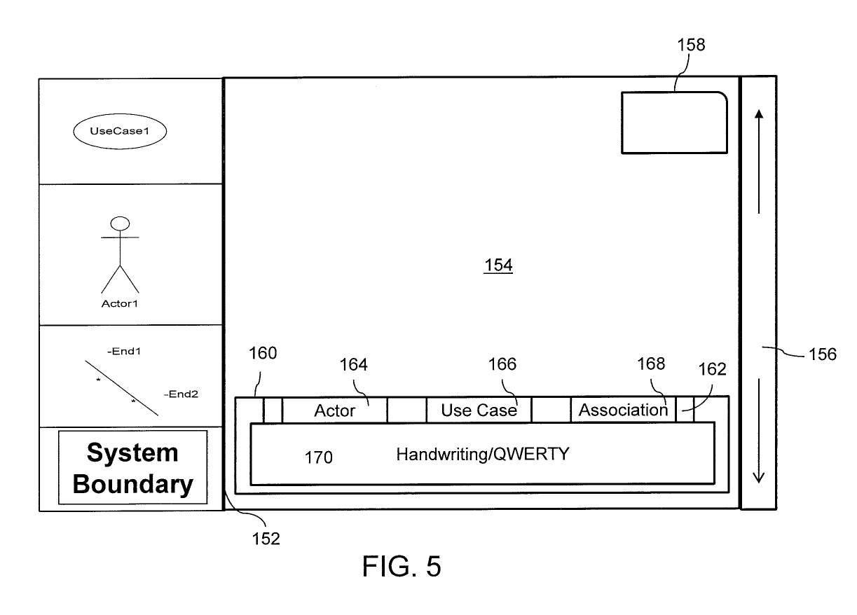

FIG. 5 illustrates an exemplary keypad of the user interface as described in FIG. 1. 160 is the Keypad and it provides two options to the user, a handwriting interface and a QWERTY keyboard. 162 is the part of the keypad that can be used in use case modeling. The user can click on an icon in workspace 154 and one of the three blocks 164, 166 and 168 shown on the top of the part 162 gets highlighted accordingly. Then, the input entered through part 170 will be taken as an input for the actor, or the action or the association which are as described in FIG. 2.

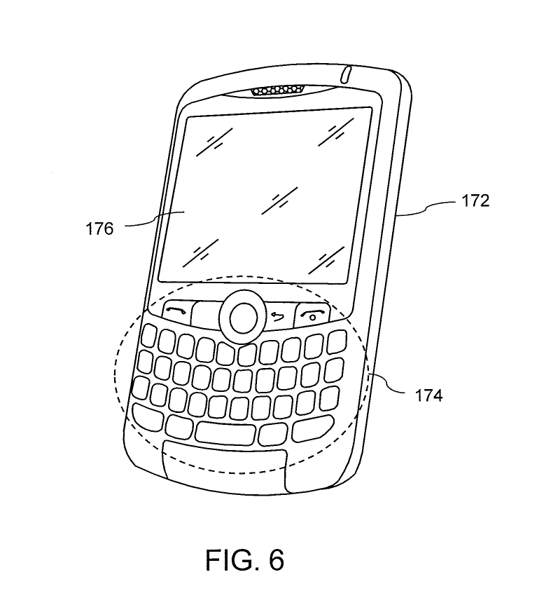

FIG. 6 is an exemplary mobile device with process modeling platform 100 installed. Mobile device 172 is shown to have an operating pad 174 and a display screen 176. A modeling platform with the logical architecture as described above can be installed on mobile device 172. The functioning of the platform will be as described above. Operating pad 174 and display screen 176 form user interface 102 of process modeling platform 100. Display screen 176 can be touch sensitive and can display a touchpad.

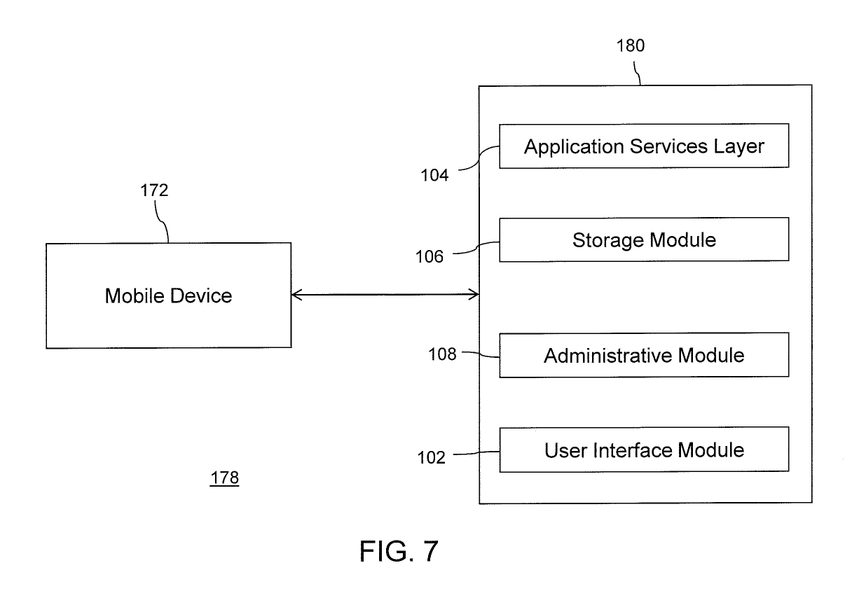

FIG. 7 is a block diagram 178 depicting another embodiment of the invention. In this embodiment, process modeling platform 100 is configured to be remotely controlled by a mobile device 172, which is as depicted in FIG. 6. In this embodiment, various modules of platform 100, which are as described above, are installed on a server, represented by block 180, which is communicatively coupled with the mobile device, represented by block 172. For example, in FIG. 7, application services layer 104, model engine 126, storage module 106, administrative module 108 and user interface 102 are shown to be installed on server 180. In an embodiment, server 180 is an enterprise server. An enterprise server is generally a computer containing programs that collectively serve the needs of an enterprise rather than a single user, department, or a specialized application.

The process modeling platform and the mobile device described above have a number of advantages. The platform, installed on a mobile device, allows a user, such as a systems engineer, to gather client discussions and model the intended processes simultaneously. It eases out the incorporation of feedback into drawn models after discussions with stakeholders. As the platform provides a uniform and consistent environment for process modeling, it smoothens the exchange of data between the involved teams. Overall it improves efficiency and productivity. Further, the platform architecture is simple and can be customized easily to work in various industry domains.

The process modeling platform, as described in the present invention or any of its components, may be embodied in the form of a computer system. Typical examples of a computer system include a general-purpose computer, a programmed microprocessor, a micro-controller, a peripheral integrated circuit element, and other devices or arrangements of devices that are capable of implementing the steps that constitute the method of the present invention.

The computer system comprises a computer, an input device, a display unit and the Internet. The computer further comprises a microprocessor, which is connected to a communication bus. The computer also includes a memory, which may include Random Access Memory (RAM) and Read Only Memory (ROM). The computer system also comprises a storage device, which can be a hard disk drive or a removable storage drive such as a floppy disk drive, an optical disk drive, etc. The storage device can also be other similar means for loading computer programs or other instructions into the computer system. The computer system also includes a communication unit, which enables the computer to connect to other databases and the Internet through an Input/Output (I/O) interface. The communication unit also enables the transfer as well as reception of data from other databases. The communication unit may include a modem, an Ethernet card, or any similar device which enable the computer system to connect to databases and networks such as Local Area Network (LAN), Metropolitan Area Network (MAN), Wide Area Network (WAN) and the Internet. The computer system facilitates inputs from a user through an input device, accessible to the system through an I/O interface.

The computer system executes a set of instructions that are stored in one or more storage elements, in order to process the input data. The storage elements may also hold data or other information as desired. The storage element may be in the form of an information source or a physical memory element present in the processing machine.

The present invention may also be embodied in a computer program product for creating and designing models for various processes. The computer program product includes a computer usable medium having a set program instructions comprising a program code for creating and designing models for various processes. The set of instructions may include various commands that instruct the processing machine to perform specific tasks such as the steps that constitute the method of the present invention. The set of instructions may be in the form of a software program. Further, the software may be in the form of a collection of separate programs, a program module with a large program or a portion of a program module, as in the present invention. The software may also include modular programming in the form of object-oriented programming. The processing of input data by the processing machine may be in response to user commands, results of previous processing or a request made by another processing machine.

While the preferred embodiments of the invention have been illustrated and described, it will be clear that the invention is not limited to these embodiments only. Numerous modifications, changes, variations, substitutions, and equivalents will be apparent to those skilled in the art without departing from the spirit and scope of the invention as described in the claims.

1. A process modeling platform installed on a mobile device, the platform comprising:
a user interface configured to enable a user to provide input related to the process and to interact with the platform, the user interface comprising:
a work space for carrying out modeling;
a template interface to enable the user to view one or more process, domain and model specific templates;
a template module communicatively coupled with the template interface, the template module configured to enable the user to access and select the one or more process, domain and model specific templates;
a model engine communicatively coupled to the user interface and the template module, the model engine configured to enable the user to access one or more algorithms to model the process corresponding to the one or more templates selected by the user; and
a storage module configured to store the model.

2. The platform of claim 1, wherein the process is a system engineering process.

3. The platform of claim 1, wherein the user interface further comprises a modeling palette, the user being able to draw a set of shapes corresponding to the model using the modeling palette.

4. The platform of claim 1, wherein the storage module further comprises:
a security sub-module for storing the model in an encrypted form;
a conversion sub-module for converting a data related to the model from a first form to a second form and from the second form to the first form; and
a native storage sub-module communicatively coupled to the conversion sub-module, the native storage sub-module for storing the data related to the model in a native format.

5. The platform of claim 1 further comprises a transfer module for communicatively connecting the mobile device with at least one external device.

6. The platform of claim 4, wherein the connection between the mobile device and the external device is one of wireless and wired.

7. The platform of claim 1, wherein the user input is multi-modal including gesture, touch, and text.

8. The platform of claim 1, wherein the storage module is one of an external and an internal memory device.

9. The platform of claim 1, wherein the storage module is also used to store the process, domain, and model specific templates and algorithms related to the model.

10. The platform of claim 1, wherein the mobile device is one of a cell phone, a laptop and a Personal Digital Assistant.

11. A process modeling platform installed on a mobile device, the platform comprising:
a user interface configured to enable a user to provide input related to the process and to interact with the platform, the user interface comprising:
a workspace for carrying out modeling, wherein access rights to the workspace can be configured;
a template interface to enable the user to view one or more process, domain and model specific templates
a template module communicatively coupled with the template interface, the template module configured to enable the user to access and select the one or more process, domain and model specific templates;
a model engine communicatively coupled to the user interface and the template module, the model engine configured to enable the user to access one or more algorithms to model the process corresponding to the one or more templates selected by the user;
a storage module for storing the model, the storage module further comprising:
a conversion sub-module for converting a data related to the model from a first form to a second form and from the second form to the first form;
a native storage sub-module for storing the data related to the model in a native format; and
an administrative module for controlling operation of any of the above modules.

12. The platform of claim 11, wherein the storage module further comprises a security sub-module for storing the model in an encrypted form.

13. The platform of claim 11 further comprises a transfer module for communicatively connecting the mobile device with at least one external device.

14. The platform of claim 13, wherein the connection between the mobile device and the external device is one of wireless and wired.

15. The platform of claim 11, wherein the user input is multi-modal including gesture, touch, and text.

16. The platform of claim 11, wherein the administrative module performs at least one of caching, authentication and authorization of the platform, error correction, controlling a connection of the mobile device with at least one external device, securing the connection between the mobile device and the external device, and back-tracking.

17. The platform of claim 11, wherein the storage module is one of an external and an internal memory device.

18. The platform of claim 11, wherein the storage module is also used to store the process, domain and model specific templates and algorithms related to the model.

19. The platform of claim 11, wherein the user interface further comprises a modeling palette, the user being able to draw a set of shapes corresponding to the model using the modeling palette.

20. The platform of claim 11, wherein the process is a system engineering process.

21. The platform of claim 11, wherein the mobile device is one of a cell phone, a laptop and a Personal Digital Assistant.

22. A mobile device comprising a process modeling platform, the platform comprising:
a user interface configured to enable a user to provide input related to the process and to interact with the platform, the user interface comprising:
a work space for carrying out modeling, wherein access rights to the workspace can be configured;
a template interface to enable the user to view one or more process, domain and model specific templates
a template module communicatively coupled with the template interface, the template module configured to enable the user to access and select the one or more process, domain and model specific templates;
a model engine communicatively coupled to the user interface and the template module, the model engine configured to enable the user to access one or more algorithms to model the process corresponding to the one or more templates selected by the user;
a storage module for storing the model, the storage module further comprising:
a conversion sub-module for converting a data related to the model from a first form to a second form and from the second form to the first form;
a native storage sub-module for storing the data related to the model in a native format; and
an administrative module for controlling the operation of any of the above modules.

23. A process modeling platform communicatively coupled with a mobile device, the platform comprising:
a user interface configured to enable a user to provide input related to the process and to interact with the platform, the user interface comprising:
a work space for carrying out modeling, wherein access rights to the workspace can be configured;
a template interface to enable the user to view one or more process, domain and model specific templates
a template module communicatively coupled with the template interface, the template module configured to enable the user to access and select the one or more process, domain and model specific templates;
a model engine communicatively coupled to the user interface and the template module, the model engine configured to enable the user to access one or more algorithms to model the process corresponding to the one or more templates selected by the user;
a storage module for storing the model, the storage module further comprising:
a conversion sub-module for converting a data related to the model from a first form to a second form and from the second form to the first form;
a native storage sub-module for storing the data related to the model in a native format; and
an administrative module for controlling the operation of any of the above modules.
